(19) United States
(12) Patent Application Publication
(10) Pub. No.: US 2007/0124609 A1
(43) Pub. Date: May 31, 2007

(54) SYSTEM AND METHOD FOR CONTROLLING CPU OVERCLOCKING

(75) Inventor: Ming-Che Lee, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,788

(22) Filed: Sep. 27, 2006

(30) Foreign Application Priority Data
Nov. 26, 2005 (CN) 200510101807.5

(51) Int. Cl. G06F 1/00

(52) U.S. Cl. 713/300

(57) ABSTRACT

An exemplary method for controlling central processing unit (CPU) overclocking is disclosed. The CPU runs in a computer system. The method includes: configuring an overclocking frequency and a reference temperature of the CPU at which the CPU begins overclocking; increasing the clock frequency of the CPU to the overclocking frequency if a real-time temperature of the CPU reaches the reference temperature; detecting whether the real-time temperature reaches a critical temperature at which the computer system would immediately power off; configuring the reference temperature and overclocking frequency by a certain increment if the real-time temperature does not reach the critical temperature; and reducing the clock frequency of the CPU if the real-time temperature reaches the critical temperature. A related system for controlling CPU overclocking is also disclosed.

### FIELD OF THE INVENTION

The present invention is generally related to systems and methods for overclocking, and particularly to a system and method for controlling central processing unit (CPU) overclocking.

### DESCRIPTION OF RELATED ART

Performances of information processing apparatuses such as personal computers and the like has had significant advancement, and in most cases, high speed central processing units (CPUs) are installed in a computer system to improve performances. However, choosing to install high speed CPUs increases the overall cost to achieve better performances.

In order to solve these problems, various methods of overclocking the CPUs have appeared. A traditional method of overclocking the CPUs is to increase the basic frequency or multiple frequency of the low speed CPUs. Generally, the frequency of the CPU is controlled by an integrated circuit (IC) or software. When the CPU is overclocked or the processing capacity is too high, because the CPU runs at full speed, the CPU can overheat easily, and the stability of the computer system will be destroyed.

Therefore, what is needed is a system and method for controlling overclocking of a CPU.

### SUMMARY OF THE INVENTION

A system for controlling central processing unit (CPU) overclocking is disclosed. The CPU is configured in a computer system. The system includes a receiving module, a detecting module and a processing module. The receiving module is configured for receiving an overclocking frequency and a reference temperature of the CPU at which the CPU begins overclocking. The detecting module is configured for detecting whether a real-time temperature of the CPU reaches the reference temperature, and whether the real-time temperature of the CPU reaches a critical temperature at which the computer system would immediately power off. The processing module is configured for increasing the clock frequency of the CPU to the overclocking frequency such that the CPU is overclocked if the real-time temperature of the CPU reaches the reference temperature, and for reducing the clock frequency of the CPU if the real-time temperature reaches the critical temperature.

A method for controlling overclocking of a CPU is disclosed. The method includes: configuring an overclocking frequency and a reference temperature of the CPU at which the CPU begins overclocking; increasing the clock frequency of the CPU to the overclocking frequency if a real-time temperature of the CPU reaches the reference temperature; detecting whether the real-time temperature reaches a critical temperature at which the computer system would immediately power off; configuring the reference temperature and overclocking frequency by a certain increment if the real-time temperature does not reach the critical temperature; and reducing the clock frequency of the CPU if the real-time temperature reaches the critical temperature.

Other advantages and novel features of the present invention will be drawn from the following detailed description of a preferred embodiment and preferred method with the attached drawings.

### BRIEF DESCRIPTION OF THE DRAWINGS

FIG. 1 is a schematic diagram of a hardware configuration of a system for controlling central processing unit (CPU) overclocking in accordance with one embodiment;

FIG. 2 is a schematic diagram of software function modules of a CPU overclocking control system; and

FIG. 3 is a flowchart of a preferred method for controlling CPU overclocking, in accordance with another embodiment.

### DETAILED DESCRIPTION OF THE INVENTION

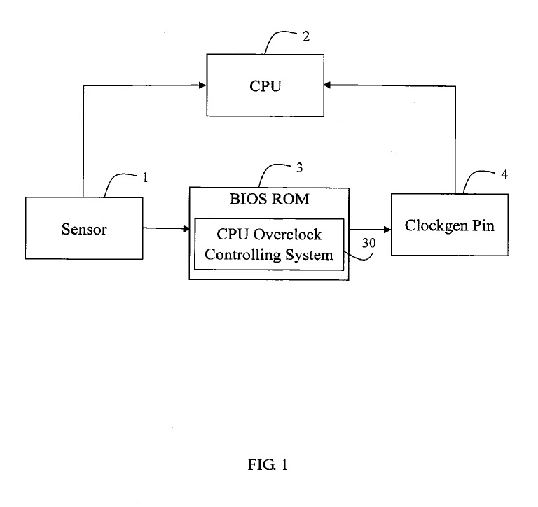

FIG. 1 is a schematic diagram of a hardware configuration of a system for controlling central processing unit (CPU) overclocking in accordance with one embodiment. The system is configured in a computer system (not shown), and typically includes a sensor 1, a CPU 2, a basic input/output system read-only memory (BIOS ROM) 3, and a clockgen pin 4. The BIOS ROM 3 stores codes of a CPU overclock controlling system 30.

The sensor 1 is connected with the CPU 2, and is configured for detecting real-time temperatures of the CPU 2 and transmitting the real-time temperatures of the CPU 2 to the CPU overclock controlling system 30. The CPU overclock controlling system 30 is configured for receiving the real-time temperatures of the CPU 2, and controlling overclocking of the CPU 2 according to the real-time temperatures. The CPU overclock controlling system 30 is further configured for signaling the clockgen pin 4 to change the clock frequency of the CPU 2 when the CPU 2 starts overheating.

The clockgen pin 4 is an integrated circuit that is connected with the CPU 2. The clockgen pin 4 stores a clockgen. The clockgen is a type of overclocking software that can be configured for changing the frequencies of the CPU 2 by changing parameters of a clock generator.

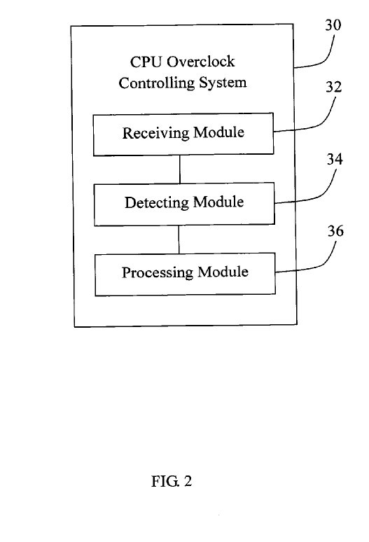

FIG. 2 is a schematic diagram of software function modules of the CPU overclock controlling system 30. The CPU overclock controlling system 30 includes a receiving module 32, a detecting module 34, and a processing module 36.

The receiving module 32 is configured for receiving configurations for a reference temperatures at which the CPU 2 begins overclocking, configurations for overclocking frequencies of the CPU 2, and a configuration for a system management interrupt (SMI). The reference temperatures are temperatures such that the CPU 2 can work normally. The SMI is configured for signaling information generated when the CPU overclock controlling system 30 controls overclocking of the CPU 2, and for transmitting the information to the clockgen pin 4 to change the clock frequency of the CPU 2.

The detecting module 34 is configured for detecting whether the real-time temperature of the CPU 2 reaches the reference temperature that is detected by the sensor 1. The CPU 2 overclocks when the real-time temperature of the CPU 2 is equal to or higher than the reference temperature but lower than the critical temperature.

The detecting module 34 is further configured for detecting whether it is the overclocking that causes the real-time temperature of the CPU 2 to reach the critical temperature. The critical temperature is higher than the reference temperature, and is set in the BIOS ROM 3 for prompting a user to perform corresponding procedures to avoid an immediately power off of the computer system.

The processing module 36 is configured for increasing the clock frequency of the CPU 2 to the overclocking frequency if the real-time temperature of the CPU 2 reaches the reference temperature. The processing module 36 is further configured for reducing the clock frequency of the CPU 2 to the clock frequency before being overclocked if the real-time temperature of the CPU 2 reaches the critical temperature. The detecting module 34 detects whether the real-time temperature of the CPU 2 decreases after the clock frequency of the CPU 2 is reduced, in order to detect whether it is overclocking that causes the real-time temperature of the CPU 2 to reach the critical temperature.

The processing module 36 is further configured for signaling the clockgen pin 4 to increase the clock frequency of the CPU 2 to the overclocking frequency via the SMI, thus overclocking the CPU 2. Furthermore, if it is overclocking that causes the real-time temperature of the CPU 2 to reach the critical temperature, the processing module 36 signals the clockgen pin 4 to reduce the clock frequency of the CPU 2 via the SMI; if it is not overclocking that causes the real-time temperature of the CPU 2 reaches the critical temperature, the processing module 36 immediate powers off the computer system.

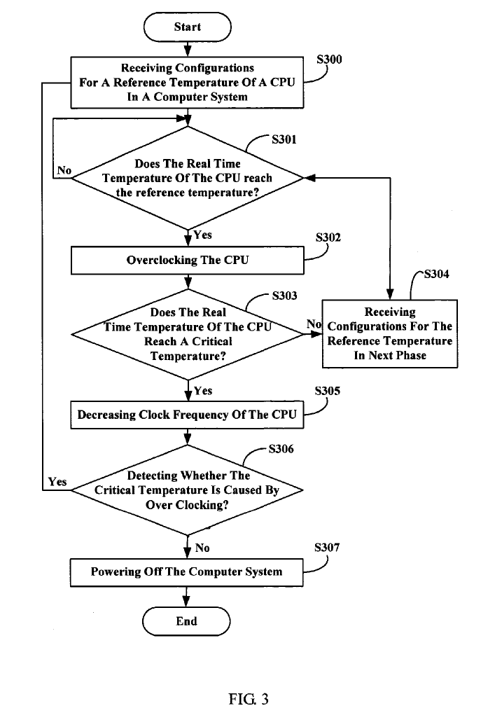

FIG. 3 is a flowchart of a preferred method for controlling the CPU 2 overclocking of in accordance with another embodiment. In step S300, the receiving module 32 receives the configuration of the reference temperature of the CPU 2, the configuration of overclocking frequency, and the configuration of the SMI from the user. The reference temperature is the temperature at which the CPU 2 begins overclocking.

In step S301, the detecting module 301 detects whether the real-time temperature of the CPU 2 reaches the reference temperature via the sensor 1.

In step S302, if the real-time temperature of the CPU 2 reaches the reference temperature in step S301, the processing module 36 signals the clockgen pin 4 to increase the clock frequency of the CPU 2 to the overclocking frequency via the SMI such that the CPU 2 is overclocked. Otherwise, the process returns to step S301.

In step S303, the detecting module 34 detects whether the real-time temperature of the CPU 2 reaches the critical temperature at which the computer system would immediately power off.

In step S304, the receiving module 32 receives the configuration for the overclocking frequency and the configuration for the reference temperature of the CPU 2 for a next overclocking phase if the real-time temperature of the CPU 2 does not reach to the critical temperature in step S303. Then, the procedure returns to the step S301.

The overclocking frequency and reference temperature of the CPU 2 in the next overclocking phase can be configured manually, and are higher than corresponding overclocking frequency and reference temperature of the CPU 2 at a present phase. For example, if the reference temperature of the present phase is thirty-six degrees centigrade, the reference temperature of the next phase can be set to thirty-eight degrees centigrade.

In step S305, the processing module 36 decreases the clock frequency of the CPU 2 if the real-time temperature of the CPU 2 reaches the critical temperature in step S303.

In step S306, the detecting module 34 detects whether the real-time temperature of the CPU 2 is decreased after the clock frequency of the CPU 2 is reduced in order to detect whether it is the overclocking that causes that the real-time temperature of the CPU 2 reaches the critical temperature.

In step S307, the processing module 36 immediately powers off the computer system if it is overclocking that causes that the real-time temperature of the CPU 2 reaches the critical temperature in step S306. For example, if the fan of the CPU 2 may be faulty or if the power supply is abnormal, the real-time temperature of the CPU 2 would reach the critical temperature.

Otherwise, if it is overclocking that causes the real-time temperature of the CPU 2 to reach the critical temperature in step S306, the process returns to step S300.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for controlling central processing unit (CPU) overclocking configured in a computer system, the system comprising:
a receiving module configured for receiving an overclocking frequency and a reference temperature of the CPU at which the CPU begins overclocking;
a detecting module configured for detecting whether a real-time temperature of the CPU reaches the reference temperature, and whether the real-time temperature of the CPU reaches a critical temperature at which the computer system would immediately power off; and
a processing module configured for increasing the clock frequency of the CPU to the overclocking frequency such that the CPU is overclocked if the real-time temperature of the CPU reaches the reference temperature, and for reducing the clock frequency of the CPU if the real-time temperature reaches the critical temperature.

2. The system according to claim 1, further comprising a sensor configured for detecting the real-time temperature of the CPU.

3. The system according to claim 1, wherein the receiving module is further configured for receiving configurations of a system management interrupt (SMI), the SMI being for signaling information generated during controlling overclocking of the CPU and transmitting the information to a frequency generator to change the clock frequency of the CPU.

4. The system according to claim 1, wherein the detecting module is further configured for detecting whether the CPU is overclocking that causes the real-time temperature of the CPU to reach the critical temperature.

5. The system according to claim 4, wherein the processing module is further configured for immediately powering off the computer system if the real-time temperature of the CPU reaching to the critical temperature is not caused by the CPU overclocking.

6. A method for controlling central processing unit (CPU) overclocking configured in a computer system, the method comprising:
configuring an overclocking frequency and a reference temperature of the CPU at which the CPU begins overclocking;
increasing the clock frequency of the CPU to the overclocking frequency if a real-time temperature of the CPU reaches the reference temperature;
detecting whether the real-time temperature reaches a critical temperature at which the computer system would immediately power off;
configuring the reference temperature and overclocking frequency by a certain increment if the real-time temperature does not reach the critical temperature; and
reducing the clock frequency of the CPU if the real-time temperature reaches the critical temperature.

7. The method according to claim 6, further comprising the steps of:
detecting whether the real-time temperature of the CPU is decreased in order to detect whether the CPU is overclocking that causes the real-time temperature of the CPU to reach the critical temperature;
returning to configure the reference temperature if the CPU is overclocking that causes the real-time temperature of the CPU to reach the critical temperature; and
immediately powering off the computer system if the real-time temperature of the CPU reaches to the critical temperature is not caused by the CPU overclocking.

8. The method according to claim 6, further comprising : configuring a system management interrupt (SMI), the SMI being for signaling information generated during controlling overclocking of the CPU and transmitting the information to a frequency generator to change the clock frequency of the CPU.
